(19) United States
(12) Patent Application Publication
(10) Pub. No.: US 2007/0055400 A1
(43) Pub. Date: Mar. 8, 2007

(54) Parametric reverse engineering method for designing tools

(76) Inventors: Fouad El Khaldi, Mennecy (FR); Marc Lambriks, Kimpen Aan Den Ijssel (NL)

Correspondence Address: BACHMAN & LAPOINTE, P.C., 900 CHAPEL STREET, SUITE 1201, NEW HAVEN, CT, 06510, US

(21) Appl. No.: 10/552,861

(22) PCT Filed: Apr. 9, 2004
(86) PCT No.: PCT/FR04/00891

§ 371 Date: Apr. 13, 2006

(30) Foreign Application Priority Data
Apr. 11, 2003 (FR) 03/04552

(51) Int. Cl. G06F 17/50

(52) U.S. Cl. 700/97; 703/1

(57) ABSTRACT

A reverse parametric engineering method for the design of tools is characterized by the following steps: importing an existing model [the design of the tool for the existing piece], production of a template for the existing tool, separation of the tool from the piece, cataloguing [saving in the form of a numerical database structured in the form of a catalogue], generating the existing tool using the section lines and characteristic lines, removing the original piece, parameterisation of the template of the existing tool [creating a parameter profile on the section lines and the characteristic lines], importing the new piece, matching the parameter template to the new piece and creating the new model, in other words the new tool for the new piece.

### BACKGROUND OF THE INVENTION

(1) Field of the Invention

The present invention relates to the field of pressing-simulation methods. The present invention relates more particularly to a parametric reverse engineering method for the design of tools.

(2) Prior Art

The conventional process for creating dies follows a cycle of iterations: design, evaluation and development from data for the part, with frequent coming and going between the steps.

The known methods of the prior art consist of implementing simulations from a CAD file. A report is produced at the end of the simulation steps but each new simulation is performed without taking account of the results of the previous ones: there is in the methods of the prior art no capitalisation according to the work already carried out.

The present invention sets out to remedy the drawbacks of the prior art by making it possible to capitalise on the experience acquired and reuse the work already carried out.

### SUMMARY OF THE INVENTION

To this end, the invention concerns, in its most general acceptance, a parametric reverse engineering method for the design of tools, characterised in that it comprises the steps consisting of:
importing an existing model (the design of an existing tool for the existing part);
producing a template for the existing tool;
separating the tool from the part;
cataloguing (saving in a numerical database structured in the form of a catalogue) the creation of the existing tool using section lines and characteristic lines;
removing the original part;
parameterising the template of the existing tool (creation of a parametric profile on the section lines and characteristic lines);
importing the new part;
making the parametric template correspond to the new part;
creating the new model, that is to say the new tool for the new part.

According to a first variant, the step consisting of making the parametric template correspond to the new part is carried out automatically.

According to a second variant, the step consisting of making the parametric template correspond to the new part is carried out interactively.

### BRIEF DESCRIPTION OF THE DRAWINGS

The invention will be understood better with the help of the description given below, purely by way of explanation, of an embodiment of the invention, with reference to the accompanying figures:

FIG. 1 illustrates the iterative process of creating dies;

FIG. 2 presents the methodology of fabricating a die;

FIGS. 3A and 3B present the input of the reverse engineering method according to the invention including the new part and the existing tool for the existing part;

FIGS. 4A, 4B, 5, 6A and 6B illustrate the reverse engineering method according to the invention. More specifically FIG. 4A illustrates the breakdown of the existing tool; FIG. 4B illustrates the die entry line; FIG. 5 illustrates the breakdown of the existing tool and reconstruction of the profile; FIG. 6A illustrates the new tool; and FIG. 6B illustrates the existing tool for the existing part.

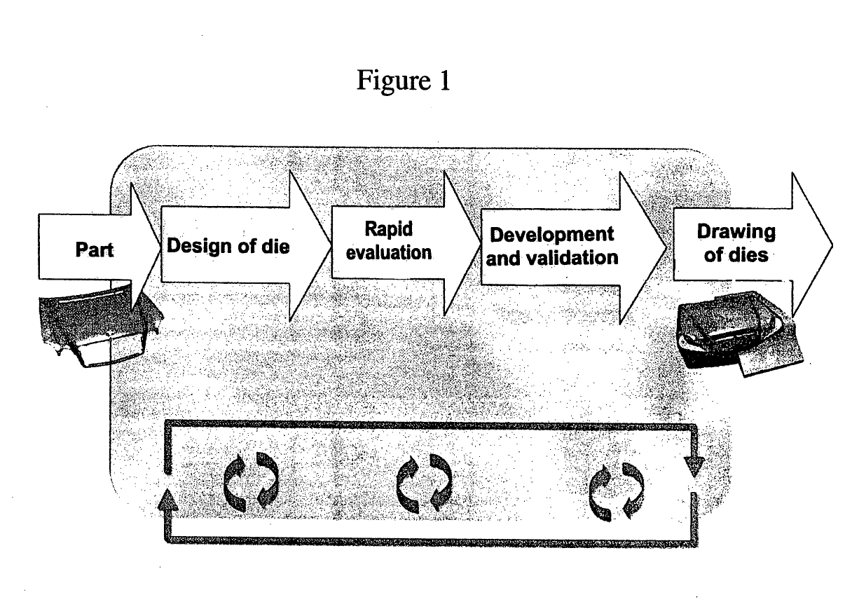

### DETAILED DESCRIPTION OF THE PREFERRED EMBODIMENT(S)

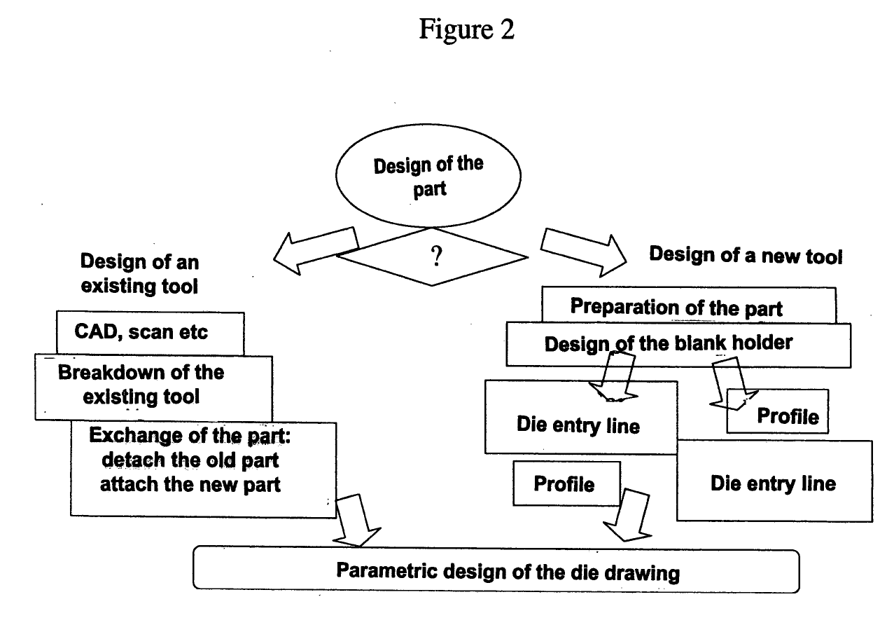

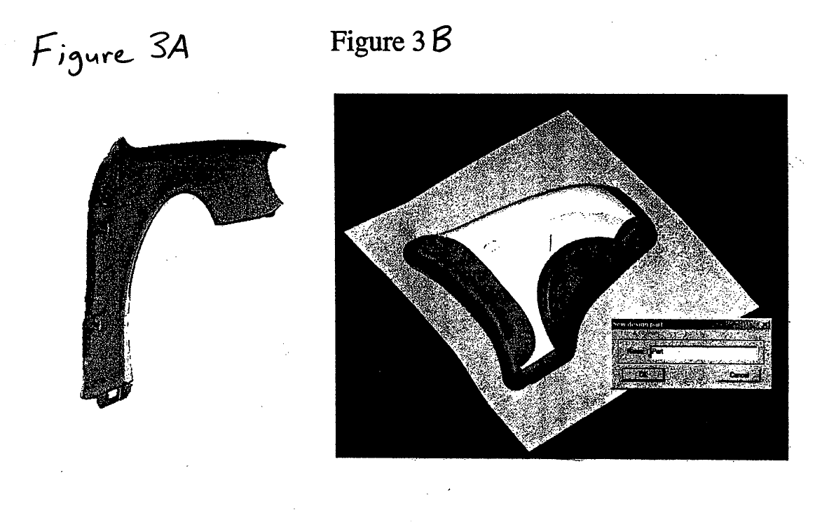

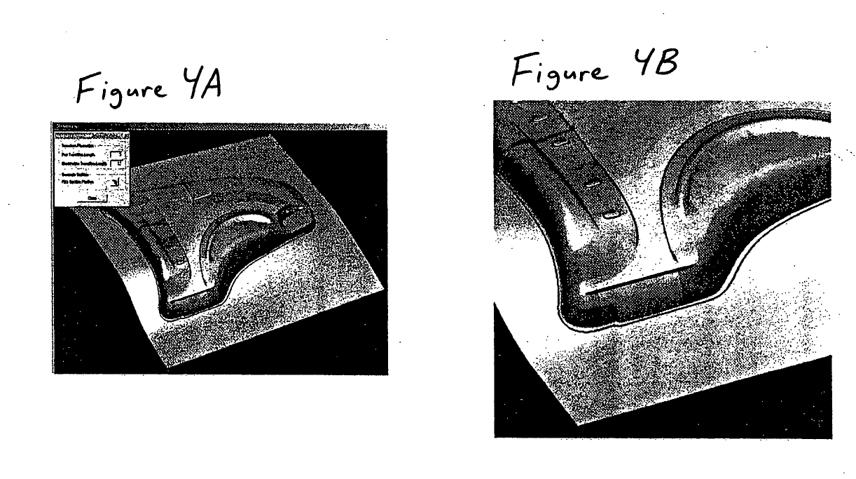

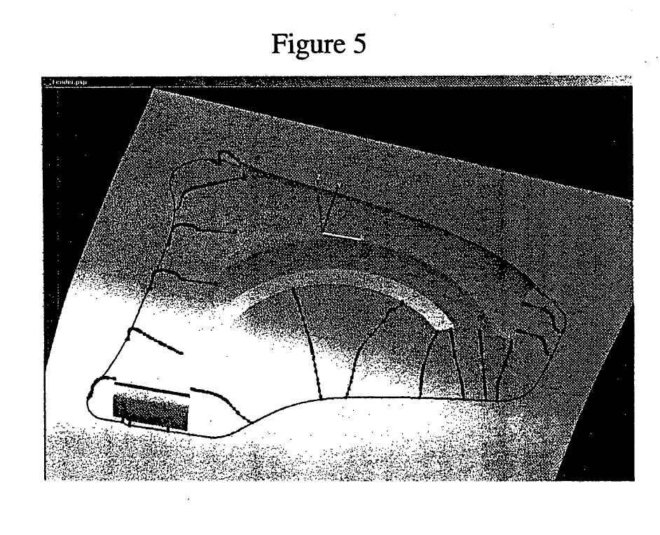

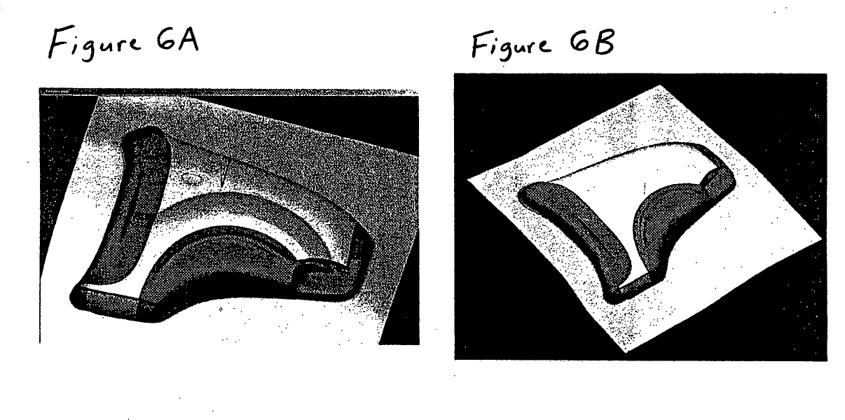

The method according to the invention makes it possible to conceive the design of the new die by working on the designs of an existing tool and a new part. The methodology of manufacturing a die is depicted in FIG. 2.

The data to be supplied as an input for implementing the method according to the invention are:
the new part
the existing tool for the existing part.

The existing tool is then broken down by automatically tracing in particular the die entry line and by reconstructing the profiles.

Another step consists of recomposing the new die using the various parametric entities (profiles, blank-holder surface, etc).

The invention is described above by way of example. Naturally a person skilled in the art is in a position to implement various variants of the invention without for all that departing from the scope of the patent.

1-3. (canceled)

4. A parametric reverse engineering method for designing tools comprising the steps of:
importing an existing model including a design of an existing tool for an existing part;
producing a template for the existing tool;
separating the existing tool from the part;
cataloguing and saving in a numerical database structured in the form of a catalogue the creation of the existing tool using section lines and characteristic lines;
removing the existing part;
parameterising the template of the existing tool by creating a parametric profile on section lines and characteristic lines;
importing a new part;
making the parametric template correspond to the new part; and
creating a new tool for the new part.

5. A parametric reverse engineering method for designing tools according to claim 4, wherein the step of parameterising the template is carried out automatically.

6. A parametric reverse engineering method for designing tools according to claim 4, wherein the step of parameterising the template is carried out interactively.
